(19) United States
(12) Patent Application Publication
(10) Pub. No.: US 2016/0335563 A1
(43) Pub. Date: Nov. 17, 2016

(54) Method and apparatus for reselling room reservations

(71) Applicants: Glenn Robert Seidman, Woodside, CA (US); Nizar Gulamhussein, Hayward, CA (US); Christen A. Scanlon, San Francisco, CA (US)

(72) Inventors: Glenn Robert Seidman, Woodside, CA (US); Nizar Gulamhussein, Hayward, CA (US); Christen A. Scanlon, San Francisco, CA (US)

(73) Assignee: Xchange Hotels, Inc., Redwood City, CA (US)

(21) Appl. No.: 14/545,515

(22) Filed: May 14, 2015

(51) Int. Cl. G06Q 10/02; G06Q 50/12; G06Q 30/06; G06Q 30/08

(52) U.S. Cl. CPC G06Q 10/02; G06Q 30/08; G06Q 50/12; G06Q 30/0625; G06Q 30/0641

(57) ABSTRACT

A computer-implemented subsystem that requires an inventive special-purpose software apparatus is disclosed. The apparatus comprises software subsystems that facilitate reselling hotel rooms or properties that have been leased, but the leaser is no longer able to make the agreed lease date and times and would like to resell their existing lease to a new leaser.

### TECHNICAL FIELD OF THE INVENTION

The present invention relates to online exchange of rooms or properties for resale of an existing lease, with emphasis on hotel rooms/suites.

### BACKGROUND OF THE INVENTION

The self-leasing of motel, hotel, and inn rooms online is commonplace today. Not only is it easy for a traveler to easily search across all hotels and motels in a geographic vicinity to find the best deal that suits them, but it is then very easy to book and pay for a room or rooms for specific dates. This ability is also available for booking flights, cars, and trains as well.

What is not easy is the recurring problem that a traveler wants their money back on a lease that they can no longer enjoy for one reason or another. This occurs because the traveler won't actually arrive to the hotel in time to actually enjoy the room they've booked or even make it to the hotel at all. This occurs due to sudden changes in one's personal circumstances; one's business schedule changing; flight delays, changes, or cancellations; weather conditions; road closures; or any other unplanned event. When one's change of circumstances occurs after the point at which the room can be cancelled, the payment for the room is lost. Meanwhile, the hotel itself would have wanted to lease the room had they known that a traveler would be a no-show.

Additionally, both travelers and Hotel Owners/Managers could benefit from being able to construct rules that will be automatically evaluated and performed to resell or buy hotel rooms when it benefits them, without any human interaction, whenever the rule conditions are met and executed.

Event Coordinators, Corporate Planners, Travel Agents, and other Travel Professionals could benefit from begin able to construct such rules to acquire blocks of rooms and then resell the ones they don't use instead of losing money on them.

Some prior art has been documented on interacting with hotel information and reservation systems to benefit the participants. Two such systems are presented below.

U.S. Pat. No. 8,688,490 discloses system and method for determining a hotel marketability index score in a network environment. A method for evaluating travel accommodations is provided that includes identifying a plurality of hotel properties and assigning a hotel marketability index score to one or more of the properties such that one or more of the properties may be ranked. The hotel marketability index score may be based on a selected one or more characteristics associated with one or more of the hotel properties, the characteristics including rate competitiveness, hotel availability, hotel location within a cluster location, and hotel quality within the cluster location.

U.S. Pat. No. 8,700,436 discloses a group reservation support system. It provides a framework that allows a user who represents a group and carries out an accommodation reservation procedure to solicit participating members while holding an accommodation.

In light of the above, there is a need for apparatus that can provide travelers a way to resell a lease to their room instead of losing all of their money and a way for hotels to know that a no-show will definitely or probably occur. For the hotel general manager, this will include an ability to determine a hotel's percentage of occupancy on a daily, weekly, monthly, or quarterly basis.

### BRIEF DESCRIPTION OF THE DRAWINGS

FIG. 1 illustrates the core ecosystem of the invention where both Room Providers and Travelers interact with the Lease Resell Server.

FIG. 2 shows the internals of the Lease Resell Server that represents the present invention.

FIG. 3 show the detailed internals of the Auction Manager subsystem of the Lease Resell Server.

FIG. 4 pictures the ecosystem with Room Block support added, showing the involvement of not only Room Providers, but now also Corporate Clients, Event Planners, and Travel Agents that need many rooms at once.

FIG. 5 pictures the Lease Resell Server again but now with the Room Block Manager subsystem.

FIG. 6 pictures the Lease Resell Server again but now with the Analyzer Manager subsystem.

FIG. 7 shows the ecosystem with rules support added, showing that all roles may create and deploy rules.

FIG. 8 pictures the Lease Resell Server again but now with both the Rule Manager and Analyzer Manager subsystems working together.

### DETAILED DESCRIPTION OF THE EMBODIMENTS

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the spirit and scope thereof. For instance, features illustrated or described as part of one embodiment may be used with another embodiment to yield a still further embodiment. Thus, it is intended that the present subject matter covers all such modifications and variations within the scope of the appended claims and their equivalents.

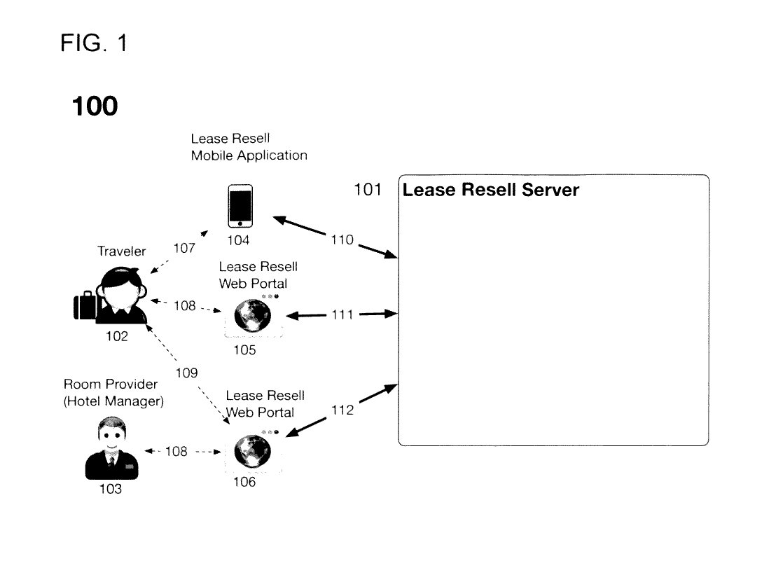

FIG. 1 (100) illustrates the core ecosystem of the present invention with the Lease Resell Server (101) handling all requests from client applications (104, 105, and 106) employed by Travelers (102) and Room Providers (103). Room Providers (103), such as Hotel Owners/Managers, utilize the Lease Resell Web Portal (106) to offer leases for Rooms for specific date ranges. Meanwhile, Travelers (102) use the Lease Resell Web Portal (105) or a Mobile Application (104) to search for Rooms for resale in a geographical location, specific hotels, for specific dates.

One embodiment of the present invention provides the means for Room Providers (103) to offer a Room for lease at a fixed lease rate. Another embodiment provides the means for Room Providers (103) to offer a Room for lease rate at a starting lease rate that is at auction for a time period and so the final highest Traveler (102) bid on a lease rate at the end of an auction will often be higher than the starting lease rate.

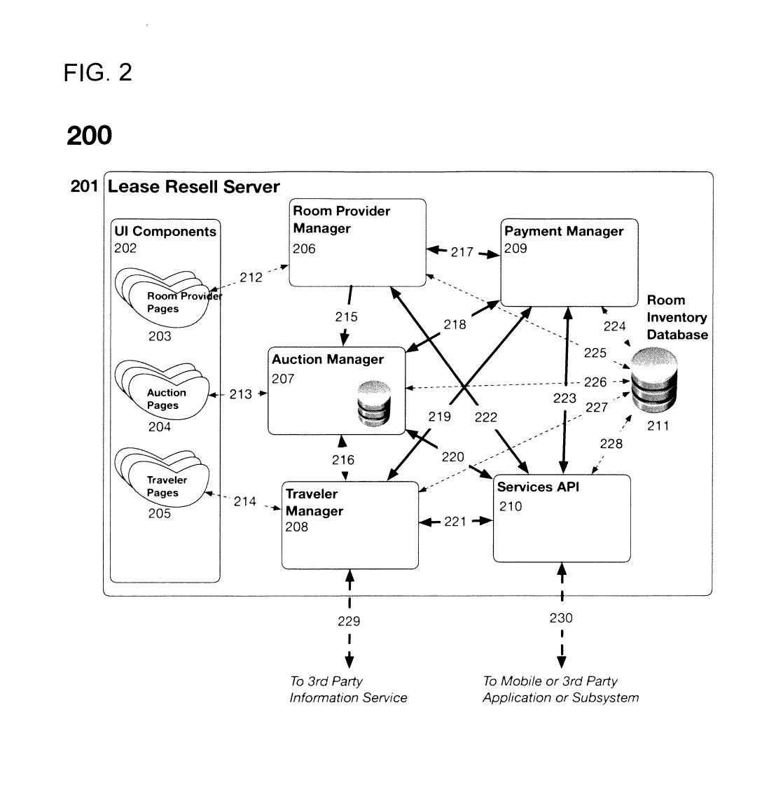

FIG. 2 (200) shows the internal subsystems of the Lease Resell Server (201) representing an embodiment of the core capabilities and benefits of the present invention. The Lease Resell Server (201) comprises UI Components (202) and other backend subsystems providing various services. UI Components (202) may be for any client application framework but a typical embodiment will deploy UI components (202) that render for web browsers. One embodiment employs Java Servlets for this purpose where in 203, 204, and 205 are presented as JavaBeans to emphasize this. Other embodiments might provide the means to present UI Components to mobile devices hosting specific client UI frameworks, although most mobile applications that interact with the Lease Resell Server (201) will interact via the Services API, which in turn, interacts with the backend systems via 220, 221, 222, 223, and 228.

The UI Components are presented as being categorized into Room Provider Pages (203), Auction Pages (204), and Traveler Pages (205).

Room Provider Pages (206) include ability for a Hotel Owner/Manager to register all of the Hotel's rooms, denote their room number or other identifying label, and categorize them into room types as well. Features such as one bed, two beds, view type (partial, ocean, valley, hills, etc.), living room, smoking/non-smoking, and floor number may be employed to describe a room type.

Room Provider Pages (206) include ability for a Hotel Owner/Manager to manage and control how the Hotel will provide Room Resell Protection, which allows a traveler leaser to resell a lease to the room. Room Resell Protection is the core novel benefit of the present invention wherein a primary use case is when a Traveler realizes circumstance changes wherein they can no longer cancel a room lease. However, with Room Resell Protection, a Traveler may beneficially decide to resell a room lease because it will be financially advantageous for them to do so. While this protection can benefit Travelers, it will also benefit Room Providers (e.g. Hotels) because it will result in a slight increase in value of the lease and ultimately also maintains an expected occupancy which is paramount to Room Providers.

The Room Provider Pages (203) interact (212) with the Room Provider Manager subsystem (206) to actually perform the room registration and room resell protection management activities. In turn, the Room Provider Manager (206) stores and retrieves the information persistently (225) about the rooms for their hotel in a private account they only can access.

One embodiment of the present invention allows Room Providers to set all of their Hotel's rooms to always providing Room Resell Protection whenever they are being offered for resale of the existing lease. An embodiment may also provide such protection throughout the year or only during certain dates during the year. An embodiment may also declare a whether such protection is free or for a declared price that is an optional component of the offered lease.

One embodiment of the present invention allows Room Providers to set a specific set of their Hotel's rooms to always providing Room Resell Protection whenever they are being offered for resale of the existing lease. An embodiment may also provide such protection only during certain dates during the year. An embodiment may also declare a whether such protection is free or for a declared price that is an optional component of the offered resale of the existing lease.

One embodiment of the present invention allows Room Providers to set a specific set of their Hotel's rooms to providing Room Resell Protection as a decision to be made when the rooms are to be offered for resale of their existing lease. An embodiment may also allow setting of the price for protection at the time the room is offered for resale of the existing lease.

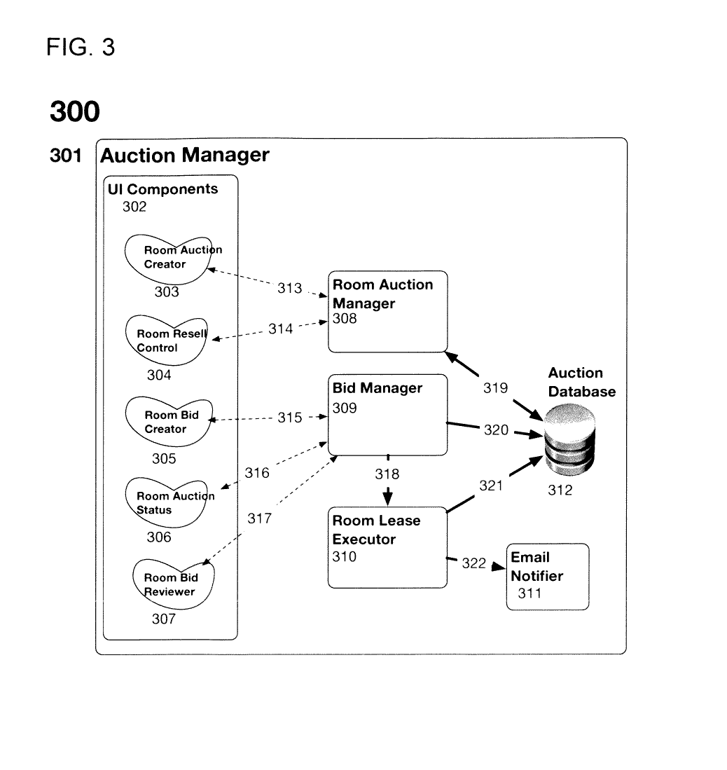

A Room Provider employs the Auction Pages (204) to actually offer a room for resale of an existing lease and will retrieve the information (215) for a Room via the Room Provider Manager (206). While the term “Auction” is used, rooms may be offered for a fixed lease rate and the first taker wins the “Auction”, wherein this is essentially not an auction. The invention description with interaction (213) to the Auction Manager (207) subsystem and corresponding Auction Manager internals diagramed in FIG. 3, are used to describe possible embodiments that employ both rooms with fixed lease rate offers as well as rooms with auctioned lease rate offers. The Auction Manager (207) will persistently store all information (226) associated with a room in the Room Inventory Database (211) including whether or not the room is offering Room Resell Protection and if it has an optional price for it.

Traveler Pages (205) include a Room Search user interface that interacts (214) with the Traveler Manager (208) subsystem to find room availability by geography (city, postal code, or address) but room availability may be looked up by specific hotel or hotels as well. The Traveler Manager must closely interact (216) with the Auction Manager (207) to default to showing only those rooms which are available for lease (at auction), however, an embodiment may search all rooms or blocks of rooms, even those that aren't available.

One embodiment of the present invention combines these searches with ratings that have been collected either by a Rate Room or Hotel Traveler Page (205). Another embodiment integrates the search with ratings retrieved from a 3^{rd} party information source (229) such as Yelp.

One embodiment of the present invention combines these searches with room type preference.

One embodiment of the present invention combines these searches with desired prices or price ranges.

One embodiment of the present invention combines these searches with the ability to sort the results by price.

One embodiment of the present invention combines these searches with the ability to sort the results by distance from a Traveler's current location.

One embodiment of the present invention provides the ability to filter search results by whether or not the hotel has a ballroom.

One embodiment of the present invention provides the ability to filter search results by whether or not the hotel has at least a specified quantity of meeting rooms.

One embodiment of the present invention combines these searches with a filter to show only those rooms offering Room Resell Protection. An embodiment may refine the filter further by allowing a maximum Room Resell Protection cost.

The Traveler Manager (208) interacts (227) with the Room Inventory Database (211) to provide information on all Hotels in all geographies in order to support the room searches presented.

Travelers use the Auction Pages (204) linked (214) from the Traveler Pages (205) to actually lease a Room found for resale of its existing lease from a Traveler Page Search.

When a room lease contract is accepted via an ended auction, the payment for the lease can be made (218) using a credit card stored privately and securely in the Payment Manager (209) for the Traveler originally set up via the Traveler Pages (205) interacting (219) with the Traveler Manager (208). Maintaining and managing Traveler accounts can be implemented by any various means known to those familiar with the art of user account with payments implementation. One approach is for the Payment Manager (209) to use an external payment service so that credit card storage and PCI issues may be avoided. One approach is for the Payment Manager (209) to store banking information directly and employ that information for payments.

One embodiment of the present invention requires Room Provider subscription payments (217) to the Payment Manager (209) for a Room Provider account and associated use of the Lease Resell Server and corresponding services.

One embodiment of the present invention requires Traveler subscription payments (219) to the Payment Manager (209) for a Traveler account and associated use of the Lease Resell Server and corresponding services.

One embodiment of the present invention persistently stores and retrieves payment information (224) for each Traveler or Room Provider account, which might purposely avoid storing the credit card information. Most embodiments will also find it beneficial to log payment activities (224) in the Room Inventory Database (211).

One embodiment of the present invention integrates the Room Inventory Database (211) with an external 3^{rd} party room inventory system in order to provide browsing of available rooms, but more importantly, to book rooms on a global centralized system that the hotel industry commonly employs already. Those familiar with the state of the art of enterprise system integration and client API development will know how to develop and configure such integration.

FIG. 3 illustrates the internal details of the Auction Manager (301) subsystem. Per the figure, we see that the Auction Pages (204) of FIG. 2 are presented in more detail. Room Providers will use the Room Auction Creator (303) to identify the room or rooms via the Traveler Manager registered rooms and set the lease rate, auction type, and Resell Protection offer (yes/no, price if selected). The auction type is either “Fixed” or “Auction”. Fixed means that the lease rate is the one offered and it cannot be bid on, only accepted or ignored. Auction means that a starting price and period for the auction is set. An embodiment may implement various auction models and those familiar with the art of auction implementation will know how to do implement a basic highest bidder auction as well as variants. The Room Auction Creator (303) employs (313) the Room Auction Manager (308) subsystem to actually create and persistently store (319) the room auction in the Auction Database (312).

Travelers will use the Room Bid Creator (305) to either agree to take a fixed lease rate offered or put a bid in on a room auction. The Room Bid Creator (305) employs (315) the Bid Manager (309) to close an auction or place a bid. Meanwhile, the Bid Manager (309) stores (320) the Bid in the Auction Database (312).

Whenever an auction closes, the highest bidder wins and the Room Lease Executor (310) is invoked (318) by the Bid Manager (309) to record the sale (321) in the Auction Database (312).

An embodiment may also notify (322) the leaser and lessor via email of the closed transaction using the Email Notifier (311). Some embodiments may notify the leaser only or the lessor only or neither. Some embodiments may provide a means for the leaser and lessor to enable or disable notifications individually.

The Room Resell Control (304) is a UI component that can be used to place anywhere on a web page or even a Mobile Application screen that denotes that a room has Room Resell Protection.

The Room Auction Status (306) User Interface provides information on the current bids and auction status of a room auction. This component interacts (316) with the Bid Manager (309) to get the current information.

The creator of a room auction, either a Room Provider or Traveler Reseller, may at any time see the history of bids via the Room Bid Reviewer (307) user interface. This component interacts (317) with the Bid Manager to get the latest bid information.

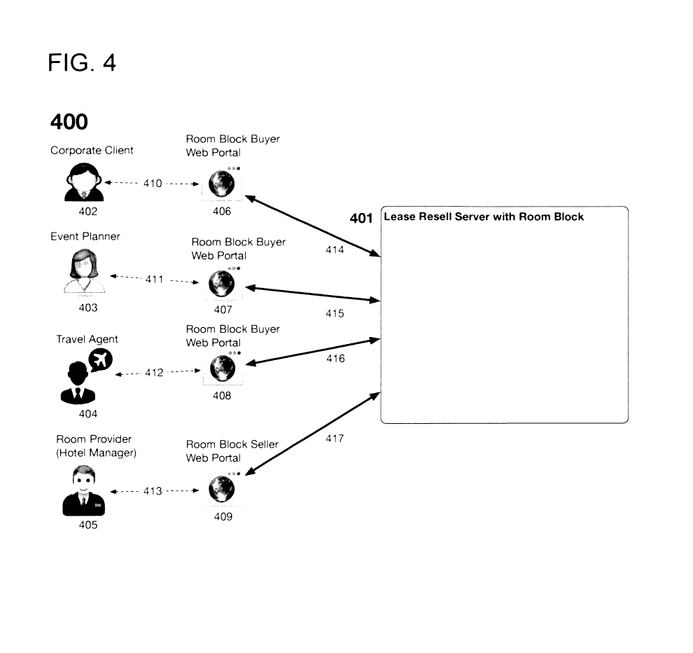

FIG. 4 depicts the ecosystem (400) for Room Block selling/reselling and buying. Basically, Room Providers (405) can offer (413) blocks of rooms via a Room Block Seller Web Portal (409), which in turn accesses the Lease Resell Server (417) for lease during specific date ranges. As illustrated, Corporate Clients (402), Event Planners (403), and Travel Agents (404) are the roles of users expected to employ the Room Block Buyer Web Portal (406, 407, 408), which interact (414, 415, 416) with the Lease Resell Server extended with Room Block support (401). Room Providers often are willing to offer a block of rooms during certain date ranges wherein they know that business is atrophied and so the block is offered at discount to attract Travelers. Such dates are known as “Need Dates”. Multiple hotels can post blocks of rooms that are then stored normally in the Room Inventory Database.

One embodiment of the present invention provides the means to offer a room block by setting the room types and quantity of each type in the block; by setting a minimum block size to lease; by setting dates of availability; and by setting either a fixed or starting auction price.

One embodiment of the present invention provides the ability to search for Room Block availability at only a specific selected list of Hotels.

One embodiment of the present invention provides the ability to search for Room Block availability at only a specific selected list of Hotel Chains.

Some embodiments provide the ability to disallow Travelers from seeing the Room Blocks offered because they are at such a discount and are to be leased in blocks.

Corporate Clients (402), Event Planners (403), and Travel Agents (404) may lease blocks and when the blocks include Room Resell Protection, these roles beneficially enjoy the ability to resell the rooms and recover what would otherwise be lost money on unused rooms.

One embodiment of the present invention provides the means for Corporate Clients (402), Event Planners (403), and Travel Agents (404) to resell their own Room Blocks which may be all or a subset of Rooms in the original Room Block they purchased.

One embodiment of the present invention provides the means for Room Providers (405) to designate a different lease rate on Rooms offered in Blocks for Corporate Clients (402), Event Planners (403), and Travel Agents (404) buyers then the lease rate offered to Travelers for Rooms in the same Room Block.

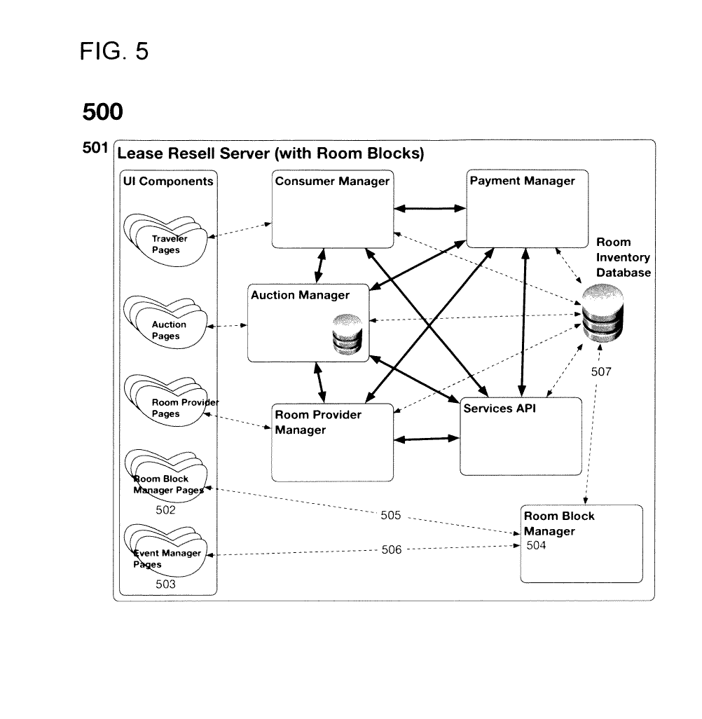

FIG. 5 pictures the Lease Resell Server (501) again but this time with Room Block support. Added, are Room Block Manager User Interface Pages (502) which provide search and retrieval of room blocks and their discounted prices (505) from the Room Block Manager (504), which in turn stores the room blocks persistently (506) in the Room Inventory Database.

Room Block support is particularly important when there are events in a geographical locale. Event Planners will employ the Event Manager user interface pages (503) to create an Event with a title and location. One embodiment of the present invention also provides the means to link a list of recommended hotels in the vicinity and this may include already commissioned room blocks by the Event Planner.

One embodiment of the present invention provides the ability for Travelers to sort search results by distance from an Event.

The Room Block Search user interface within the Room Block Manager pages (502) beneficially provides the means to request a specific quantity of rooms and it is able to answer multiple blocks of rooms from one or more hotels in a geographic locale to satisfy the request.

One embodiment of the present invention provides a services API that supports all of the presented room block functionality.

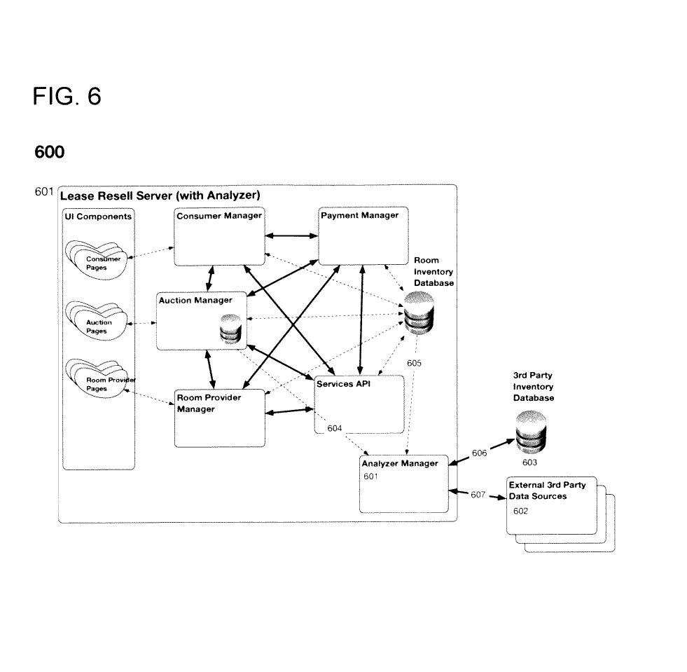

FIG. 6 diagrams the Lease Resell Server again but this time with an Analyzer Manager (602). One embodiment employs (607) additional external information during analysis such as an External 3^{rd} Party Data Sources (602).

One embodiment employs (606) additional external information during analysis such as a 3^{rd} Party Inventory Database or Databases (603).

The Analyzer Manager may retrieve current auction information (604) and current room inventory information (605).

One embodiment includes a travel analyzer that employs external 3^{rd} party information sources (602) on behalf of a Traveler who has provided access to their itinerary. This travel analyzer potentially retrieves (607) flight, train, car, weather, and road information and analyzes each leg of travel based on reservations for travel and public transpiration schedules, while adding up the best times of arrivals for the completion of each leg. A late probability distribution is determined relative to the maximum check-in allowed. When it is determined that the Traveler definitely won't make the maximum check-in time, the Analyzer Manager marks the Traveler's arrival to the hotel as such. Some embodiments will automatically transfer a Room Reservation back to the Hotel when a Traveler's arrival is computed as not possible and the Room does not have Room Resell Protection.

One embodiment includes a room price analyzer that groups rooms and their lease rates per hotel and per room type and computes min, max, standard deviation, and average lease rate per room type for a specified date and time range.

One embodiment includes a room price analyzer that groups rooms and their lease rates per geographic locale and per room type and computes min, max, standard deviation, and average lease rate per room type for a specified date and time range.

One embodiment includes a room occupancy analyzer that groups rooms and their occupancy percentages per geographic locale and per room type for a specified date and time range.

One embodiment includes a room occupancy analyzer that groups rooms and their occupancy percentages per hotel and per room type for a specified date and time range.

One embodiment of the present invention provides the ability to aid a Traveler in selecting a resale price for an existing lease. Such embodiments provide a histogram of Price vs. Probability given a quantity of hours that will be required to resell the Room. This is based on correlating all known times it took to sell a Room for various prices recorded in the last M days as well as the same recent M days in the previous year, where M is configurable. The number of days required will be weighted more toward recent data but the weighting factors for recent vs. last year need to be configured since seasonal behavior is important. Some embodiments provide a GUI with a Price slider and Number of Hours desired slider with a dynamically updating histogram as the slider is employed.

One embodiment of the present invention provides the ability to aid a Traveler in selecting a resale price for an existing lease by providing a histogram of Price vs. Number of Hours given a probability that will be required to resell the Room. This is based on correlating all known success rates it took to sell a Room for various prices in N days recorded in the last M days as well as the same recent M days in the previous year, where M is configurable. The success rate observed will be weighted more toward recent data but the weighting factors for recent vs. last year need to be configured since seasonal behavior is important. Some embodiments provide a GUI with a Price slider and a Probability slider with a dynamically updating histogram as the slider is employed.

One embodiment of the present invention provides a services API that supports retrieving of any or all of the previously mentioned analytics information.

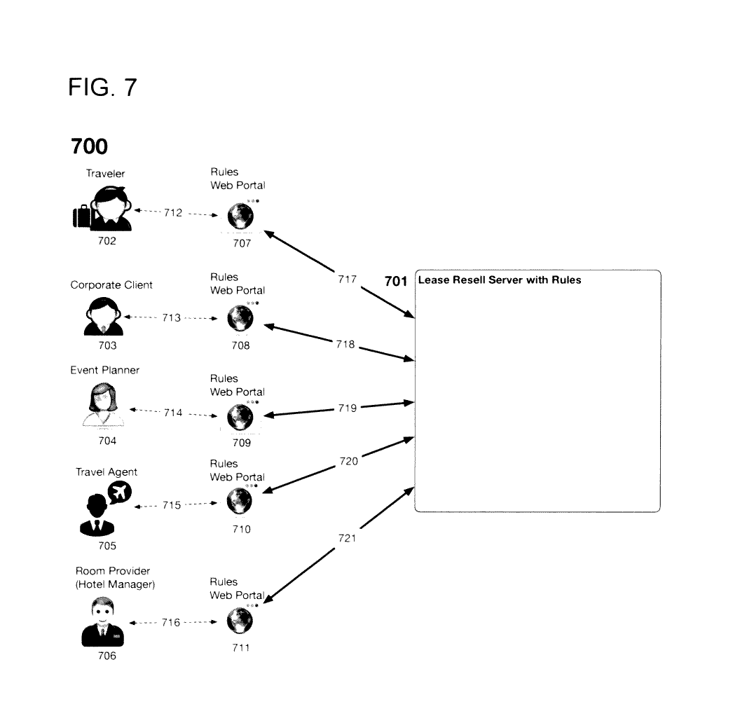

FIG. 7 depicts the ecosystem again but this time shows the Lease Resell Server with Rule Support (701) and emphasizes that all roles (702, 703, 704, 705, 706) may employ (712, 713, 714, 715, 716) a Rules Web Portal (707, 708, 709, 710, 711) to create and manage rules (717, 718, 719, 720, 721) in their accounts to perform various tasks automatically when conditions are met.

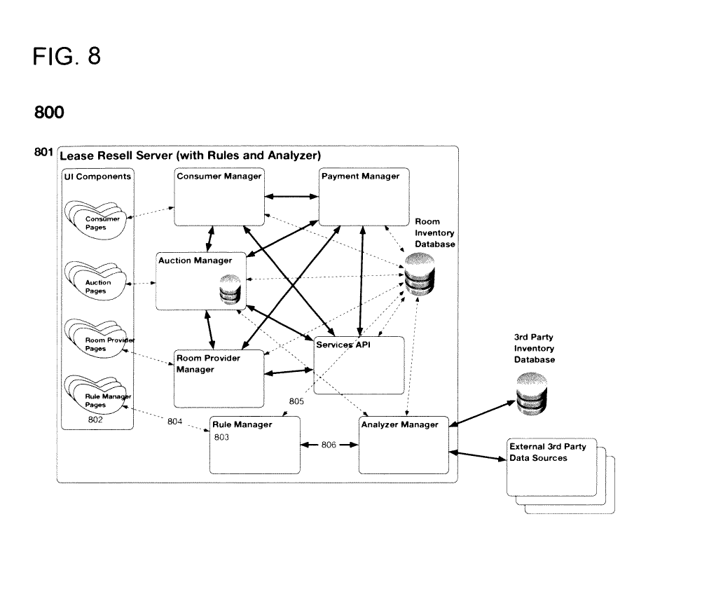

FIG. 8 pictures the Lease Resell Server again but now with both the Rule Manager user interface pages (802) and Analyzer Manager subsystems working together in order to enable the roles of FIG. 7 to realize working rules. The Rule Manager pages (802) interacts with the Rule Manager (803) to create, edit, delete, as well as enable and disable rules. Rule details are persistently stored (805) in the Room Inventory Database.

One embodiment of the present invention employs rules that are a 3-tuple of (system event, condition, task list). The Rule Manager performs the task list only when the stated system event occurs and the condition stated is true.

The Rule Manager largely interacts (806) with the Analyzer Manger to evaluate conditions relative to specific analysis. Thus, rules may reference information from the previously mentioned travel analyzer, room price analyzer, and room occupancy analyzer.

One embodiment of the present invention allows a rule to be triggered when an Event is created via the Event Manager user interface in a specific geographic locale.

One embodiment of the present invention provides the means to generate an event that can be used as a rule event for specific Boolean expressions on analysis information. For example, a price threshold can be exceeded or fall below and produce an event for a rule.

One embodiment of the present invention provides a services API that supports creating, updating, and deleting rules.

One embodiment of the present invention provides streaming events to an external client via any streaming protocol.

One embodiment of the present invention provides the ability for 3^{rd} party room reservation websites to employ an API (210) that allows them to register a Room for Room Resell Protection in the Lease Resell Server (201). By registering a Room Reservation in the Lease Resell Server, the User who owns the Room Reservation may then enjoy all the benefits of the invention including creating an auction to resell the existing lease at will, participating in analysis, as well as setting rules to resell the Room Reservation via computer automatically. When necessary to coordinate the Room in a standardized global universal system, such an embodiment interacts with an external Room Inventory Database.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the spirit and scope of the present invention, which is more particularly set forth in the appended claims.

What is claimed is:

1. A system for electronically bidding, offering, booking, and paying for leasing hotel rooms or properties, the system comprising:
a memory device to store sets of instructions; and at least one possessor coupled with the memory device to execute the set of instructions; wherein the sets of instructions cause the at least one processor to:
implement a room auction creator user interface configured to allow a single hotel owner/manager to create a room auction by entering information about a room, by setting a quantity for the room; by setting dates of availability; by setting either a fixed asking price or start auction price for the room; by setting an expiration date and time; by setting whether or not room resell protection is offered; and by setting a price for room resell protection when offered.
implement a room bid creator user interface configured to allow each one of a plurality of traveler bidders to place a bid on a selected room auction and for a specific selection of dates;
implement a room auction status user interface configured to provide all traveler and seller searchers, traveler bidders, and room sellers information about the auction including the current highest bid and the time left for the auction;
implement a room lease executor configured to execute a sale for a room lease contract when the room auction ends, transferring funds between winning traveler bidder and room seller, transferring the room lease contract from the room seller to the winning traveler bidder so that the contract now is between the hotel owner/manager of the room and the winning traveler bidder, where the traveler, room reseller, and the hotel receive a notification of the sale execution and/or it shows in an activity history private to each person's account.
implement a room resell protection user control that allows a traveler to resell a room they lease if selected;
implement a room resell auction creator user interface configured to allow a single traveler with an existing room lease contract to resell the room's lease at auction by first having the known room information automatically copied into the resell auction; by the traveler resetting dates of availability; by the traveler setting either a fixed asking price or start auction price for the room; and by the traveler setting an expiration date and time.

2. The system of claim 1 further comprising a room search user interface that provides the means for a traveler to search for hotel rooms comprising filtering or grouping by room resell protection.

3. The system of claim 1 further comprising a travel analyzer that:
retrieves flight, train, car, weather, and road information from one or more information sources;
analyzes the legs of travel for each user knowing their flight, train, car reservations and schedules while adding up the best times of arrival for the completion of each leg;
determines a minutes late probability distribution for each traveler relative to the maximum check-in time allowed;
determines whether the traveler definitely won't make the maximum check-in time or not and marks them as such;
sends a notification to the hotel owner and traveler of the fact that the traveler won't make the maximum check-in time and/or it shows in an activity history private to each person's account.

4. The system of claim 3 further comprising an ability for a traveler with room resell protection to set a rule that automatically creates a room resell auction for the traveler as soon as it is determined that they won't make the maximum check-in time for the room lease contract.

5. The system of claim 3 further comprising an ability for a hotel owner to set a rule that automatically creates a room resell auction for the hotel owner as soon as it is determined that a traveler without room resell protection won't make the maximum check-in time for the room lease contract.

6. The system of claim 4 further comprising an ability for a traveler with room resell protection to set a rule that automatically creates a room resell auction on a certain date.

7. The system of claim 1 further comprising a room price analyzer that groups rooms and their associated lease rates per hotel and per room type and computes minimum, maximum, standard deviation, and average lease rate per room type for a specified date and time range.

8. The system of claim 1 further comprising a room price analyzer that groups rooms and their associated lease rates per geographic region and per room type and computes minimum, maximum, standard deviation, and average lease rate per room type for a specified date and time range.

9. The system of claim 4 further comprising an ability for a traveler with room resell protection to set a rule that automatically creates a room resell auction when for a hotel or geographic region for their room type, the minimum, maximum, or average price rises above or falls below a set limit.

10. The system of claim 4 further comprising an ability for a traveler with room resell protection to set a rule that automatically creates a room resell auction when it is possible to gain a room matching specific criteria nearby for a lesser lease rate, wherein once the room is successfully resold, a bid or immediate lease may be submitted for the lesser rate room.

11. The system of claim 1 further comprising a room occupancy analyzer that groups rooms and their associated occupancy rates per hotel and per room type for specified dates and times.

12. The system of claim 1 further comprising a room occupancy analyzer that groups rooms and their associated occupancy rates per geographic region and per room type for a specified date and time range.

13. The system of claim 4 further comprising an ability for a traveler with room resell protection to set a rule that automatically creates a room resell auction when for a hotel or geographic region for their room type, the occupancy rate rises above or falls below a set limit.

14. The system of claim 1 further comprising an event creator user interface configured to allow an event planner to create an event by setting an event title, by setting an industry, by setting an event type, by setting an event description that includes pictures, by setting a geographic location, and by setting a projected number of out of town attendees.

15. The system of claim 14 further comprising an event creator user interface configured to link the event to a recommended list of hotels.

16. The system of claim 14 further comprising a room search user interface that provides the means for a traveler to search for hotel rooms comprising filtering by event.

17. The system of claim 15 further comprising a room search user interface that provides the means for a traveler to search for hotel rooms comprising filtering by event linked hotels.

18. The system of claim 4 further comprising an ability for a traveler to set a rule that automatically creates a room resell auction when an event title, event industry, or event type in the same hotel as the room is created.

19. The system of claim 4 further comprising an ability for a traveler to set a rule that automatically creates a room resell auction when an event title, event industry, or event type in the same geographic region as the room is created.

20. The system of claim 1 further comprising a room block creator user interface configured to allow a single hotel owner/manager to create a block of rooms auction by entering information about the rooms, by setting the room types and quantity of each type, by setting minimum block size portion of the entire block that may be leased; by setting dates of availability; by setting either a fixed asking price or start auction price for the rooms; by setting an expiration date and time; by setting whether or not room resell protection is offered; and by setting a price for room resell protection when offered.

21. The system of claim 20 further comprising a room block search user interface configured to answer a room block from one or more hotels in a geographic locale to satisfy a quantity of rooms search request.

22. The system of claim 1 further comprising a room resell API that may be employed by 3^{rd} parties to programmatically create room resale of existing lease auctions, retrieve current room for resale of existing lease auction information, bid on a room resale of existing lease auction.

23. The system of claim 1 further comprising a room resell API that may be employed by 3^{rd} parties to programmatically store a room lease contract having room resell protection.

24. The system of claim 1 further comprising a room resell API that may be employed by 3^{rd} parties to programmatically retrieve travel analyzer information and retrieve room price analyzer information.

25. The system of claim 1 further comprising a room resell API that may be employed by 3^{rd} parties to programmatically retrieve room occupancy analyzer information.

26. The system of claim 1 further comprising a room resell API that may be employed by 3^{rd} parties to programmatically create, retrieve, edit, and delete rules.

27. The system of claim 1 further comprising a room resell API that may be employed by 3^{rd} parties to programmatically create an event, and search for events based on title, industry, or type.
